(19) United States
(12) Patent Application Publication
(10) Pub. No.: US 2009/0003003 A1
(43) Pub. Date: Jan. 1, 2009

(54) Light Emitting Device, Light Emitting Device Package Structure, and Method of Manufacturing the Light Emitting Device Package Structure

(76) Inventor: Byoung Jae Park, Gwangju (KR)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/661,049

(22) PCT Filed: Aug. 24, 2005
(86) PCT No.: PCT/KR2005/002794

§ 371 Date: Jul. 15, 2008

(30) Foreign Application Priority Data
Aug. 25, 2004 (KR) 10-2004-0067263

(51) Int. Cl. B60Q 1/06; H01J 9/00

(52) U.S. Cl. 362/373; 445/23

(57) ABSTRACT

Provided are a light emitting device, a light emitting device package structure, and a method of manufacturing the light emitting device package structure. The light emitting device package structure includes a heat-dissipating main plate formed of a heat-dissipating material, in which a first receiving groove has an opened top and a first inclined portion has an inner diameter that gradually decreases toward a lower position, at least one insulating bead which is formed of an insulating material and penetrates a bottom surface of the first receiving groove from a base of the heat-dissipating main plate, and at least one lead frame which penetrates the insulating bead. According to the light emitting device, the light emitting device package structure, and the manufacturing method of the light emitting device package structure, an LED chip can be mounted on a large-scale heat-dissipating main plate and light can be focused, thereby improving light emitting efficiency and heat-dissipating capability.

### TECHNICAL FIELD

The present invention relates to a light emitting device, a light emitting device package structure, and a method of manufacturing the light emitting device package structure, and more particularly, to a light emitting device having a heat-dissipating and light-focusing structure suitable for high-output applications, a light emitting device package structure, and a method of manufacturing the light emitting device package structure.

### BACKGROUND ART

With the recent introduction of a structure capable of creating and radiating white light using fluorescent substance, the application range of a light emitting diode (LED) has been extended to the field of illumination capable of substituting for conventional lighting, let alone a simple light-emitting display function. Thus, research has been steadily undertaken on an LED for high-output applications such as lighting.

As the temperature increases over rated operating temperature, the life span and light emitting efficiency of an LED, which is one of semiconductor devices, are reduced. As a result, to improve the output of the LED, there is a need for a heat-dissipating structure capable of operating at as low an operating temperature as possible by effectively dissipating heat generated in the LED.

However, a conventional LED includes a structure in which a lead frame having an LED chip mounted is molded with a plastic material. Since heat dissipation is made through the lead frame, the conventional LED has poor heat-dissipation capability and is thus difficult to apply to high-output applications. Moreover, when an ultraviolet LED chip is used, the plastic material used for molding of the lead frame is easily deteriorated by ultraviolet rays radiated from the ultraviolet LED chip, causing degradation in durability.

### DISCLOSURE OF INVENTION

### Technical Problem

To solve the above problems, it is an objective of the present invention to provide a light emitting device that is easy to manufacture while improving heat-dissipation capability and light-emitting efficiency, a light emitting devicepackage structure, and a method of manufacturing the light emitting device package structure.

### Technical Solution

To accomplish the above object of the present invention, there is provided a light emitting device package structure. The light emitting device package structure includes a heat-dissipating main plate, at least one insulating bead, and at least one lead frame. The heat-dissipating main plate is formed of a heat-dissipating material, in which a first receiving groove has an opened top and a first inclined portion has an inner diameter that gradually decreases toward a lower position. The insulating bead is formed of an insulating material and penetrates a bottom surface of the first receiving groove from a base of the heat-dissipating main plate. The lead frame penetrates the insulating bead.

Preferably, the heat-dissipating main plate includes a second receiving groove that is cut to a predetermined depth in the center of the bottom surface of the first receiving groove to mount a light emitting device chip.

In addition, the second receiving groove may have a second inclined portion whose outer diameter gradually decreases towards a lower position.

Preferably, the heat-dissipating main plate comprises a first body portion which is extended to a predetermined length from its top to have the same outer diameter from top to bottom, and a second body portion which is extended concentrically with the first body portion by a predetermined length from the bottom of the first body portion to have an outer diameter that is larger than that of the first body portion.

More preferably, the heat-dissipating main plate comprises a lens mounting groove that has a step of a predetermined depth from the top edge of the first body portion and is then extended to the top of the first inclined portion.

In another aspect of the present invention, the first insulating bead is formed in the center of the heat-dissipating main plate, and the light emitting device further comprises a first lead frame which penetrates the first insulating bead, and a second lead frame which is formed in the base of the heat-dissipating main plate.

In addition, the lead frame may have a bent portion that is bent in parallel with the base of the heat-dissipating main plate and is extended while being spaced apart from the base of the heat-dissipating main plate, in which the lead frame penetrates the heat-dissipating main plate for surface mounting.

More preferably, in the base of the heat-dissipating main plate, at least one third receiving groove is further formed, in which the third receiving groove is cut from the inner portion to the outer portion of the base of the heat-dissipating main plate to a pre-determined length, so that the bent portion is partially accommodated in the third receiving groove while being spaced apart from the third receiving groove.

In still another aspect of the present invention, there is provided a light emitting device comprising a heat-dissipating main plate formed of a heat-dissipating material, in which a first receiving groove has an opened top and a first inclined portion has an inner diameter that gradually decreases toward a lower position, at least one insulating bead which is formed of an insulating material and penetrates a bottom surface of the first receiving groove from a base of the heat-dissipating main plate, at least one lead frame which penetrates the insulating bead, at least one light emitting device chip which is mounted in the first receiving groove of the heat-dissipating main plate and is electrically connected to the lead frame, and a cap which is formed in the heat-dissipating main plate to hermetically seal the internal space of the first receiving groove in which the light emitting device chip is mounted.

In addition, the heat-dissipating main plate includes a second receiving groove that is cut to a predetermined depth in the center of the bottom surface of the first receiving groove to mount a light emitting device chip.

The light emitting device further comprise a fluorescent substance filled in the second receiving groove to surround the LED chip mounted on the second receiving groove.

In addition, the heat-dissipating main plate comprises a lens mounting groove that has a step of a predetermined depth from the top edge of the first body portion and is then extended to the top of the first inclined portion, and the cap used is a lens inserted into and combined with the lens mounting groove to be mounted in the heat-dissipating main plate.

According to another aspect of the present invention, there is provided a method of manufacturing a light emitting device package structure, the method comprising forming a heat-dissipating main plate having a first receiving groove and at least one insertion hole, in which the first receiving groove has an opened top, a first inclined portion has an inner diameter that gradually decreases toward a lower position, and the insertion hole penetrates a bottom surface of the first receiving groove, inserting an insulating bead having a hollow into the insertion hole of the heat-dissipating main plate and inserting a lead frame through the hollow of the insulating bead, and performing a heating process to solder the insulating bead to the heat-dissipating main plate and the lead frame.

### BRIEF DESCRIPTION OF THE DRAWINGS

FIG. 1 is a perspective view of a light emitting device package structure according to a first embodiment of the present invention;

FIG. 2 is a cross-sectional perspective view of FIG. 1;

FIG. 3 is a cross-sectional view of a light emitting device according to a first embodiment of the present invention, to which the light emitting device package structure of FIG. 1 is applied;

FIG. 4 is a cross-sectional view of a light emitting device according to a second embodiment of the present invention, to which the light emitting device package structure of FIG. 1 is applied to;

FIG. 5 is a cross-sectional view of a light emitting device according to a third embodiment of the present invention, to which the light emitting device package structure of FIG. 1 is applied to;

FIG. 6 is a cross-sectional view of a light emitting device package structure according to a second embodiment of the present invention;

FIG. 7 is a cross-sectional view of a light emitting device to which the light emitting device package structure of FIG. 6 is applied;

FIG. 8 is a cross-sectional view of a light emitting device package structure according to a third embodiment of the present invention; and

FIG. 9 is a perspective view of the bottom of the light emitting device package structure of FIG. 8 in the upside down position.

### BEST MODE FOR CARRYING OUT THE INVENTION

Hereinafter, a light emitting device, a light emitting device package structure, and a method of manufacturing the light emitting device package structure according to embodiments of the present invention will be described in detail with reference to the attached drawings.

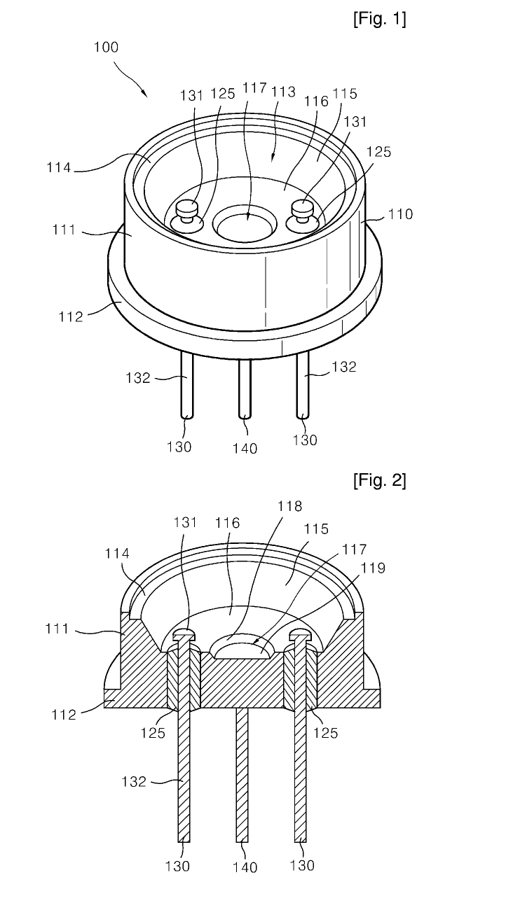

FIG. 1 is a perspective view of a light emitting device package structure according to a first embodiment of the present invention, and FIG. 2 is a cross-sectional perspective view of FIG. 1.

Referring to FIGS. 1 and 2, a light emitting device package structure 100 includes a heat-dissipating main plate 110, an insulating bead 125, and a lead frame 130.

The heat-dissipating main plate 110 has an external structure in which a first body portion 111 and a second body portion 112 having different outer diameters are concentrically extended with a step between them, thereby forming a two-step cylinder shape.

In other words, the heat-dissipating main plate 110 includes the first body portion 111 that is extended to a predetermined length from its top to have the same outer diameter from top to bottom and the second body portion 112 that is extended to a pre-determined length from the bottom of the first body portion 111 concentrically with the first body portion 111 to have an outer diameter that is larger than that of the first body portion 111.

Since the outer diameter of the second body portion 112 is larger than that of the first body portion 111 and a flange-type protrusion is formed, an auxiliary heat-dissipating member 260 having an inner diameter equal to the outer diameter of the first body portion 111 can be inserted and combined through the first body portion 111 to improve heat-dissipation capability, as shown in FIG. 5.

The second body portion 112 is expanded larger than the first body portion 111, but may take other shapes in addition to a circular shape shown in the drawings.

The heat-dissipating main plate 110 has a first receiving groove 113 with an opened top.

The heat-dissipating main plate 110 has a lens mounting groove 114 that is vertically cut to a predetermined depth at a position inwardly spaced by a pre-determined distance from the top edge of the first body portion 111 and is then horizontally extended by a predetermined length.

The heat-dissipating main plate 110 also has a first inclined portion 115 whose inner diameter gradually decreases toward a lower position from the internal edge of the lens mounting groove 114.

It is preferable that the first inclined portion 115 be formed to function as a reflecting mirror capable of upwardly reflecting light that is radiated from an LED chip to be mounted to focus the radiated light. In this case, it is preferable that the heat-dissipating main plate 110 be formed of a material having a heat-dissipating function and a high reflectivity, or the entire surface of the heat-dissipating main plate 110 or at least the surface of the first inclined portion 115 be coated with at least one of silver, nickel, and aluminum.

In the center of a bottom surface 116 of the first receiving groove 113, a second receiving groove 117 is cut to a predetermined depth for the mounting of the LED chip.

The second receiving groove 117 has a second inclined portion 118 whose outer diameter gradually decreases toward a lower position. It is preferable that the second inclined portion 118 of the second receiving groove 117 be formed of the above-described material to function as a reflecting mirror capable of upwardly reflecting light that is radiated from the LED chip to be mounted to focus the radiated light.

A bottom surface 119 of the second receiving groove 117 is used as an area where the LED chip is mounted.

The second receiving groove 117 guides the mounting position of the LED chip. When a fluorescent substance is applied to a layer, the layer can be easily defined within the second receiving groove 117.

The heat-dissipating main plate 110 is formed of a heat-dissipating material having superior thermal conductivity, e.g., a metal material or a ceramic material.

The heat-dissipating main plate 110 may be formed of copper or a copper-alloy, e.g., brass, a tungsten-copper alloy, a molybden-copper alloy, AlN, or SiC.

Preferably, the heat-dissipating main plate 110 is formed of the above-described heat-dissipating material to have the above-described structure and is plated with a nickel material to have an anti-corrosion characteristic. More preferably, the heat-dissipating main plate 110 is secondarily plated with silver or gold on the nickel-plated layer to improve reflection efficiency and wire-bonding.

The insulating bead 125 penetrates the bottom surface 116 of the heat-dissipating main plate 110 in the base of the first receiving groove 113.

It is preferable that the insulating bead 125 be formed of an insulating material, such as glass, an epoxy material, or a ceramic material, which has high melting point and is easily welded to other kinds of materials when heated.

The lead frame 130 is surrounded by the insulating bead 125 to be insulated from the heat-dissipating main plate 110.

One end of the lead frame 130 is exposed in the first receiving groove 113 of the heat-dissipating main plate 110 and the other end is externally protruded from the base of the heat-dissipating main plate 110.

The lead frame 130 includes a head portion 131 and a leg portion 132.

The head portion 131 has an outer diameter that is larger than that of the leg portion 132 to facilitate wire-bonding.

A lead frame 140 directly combined with the base of the heat-dissipating main plate 110 may be used for grounding or for an electrode, and may not be included.

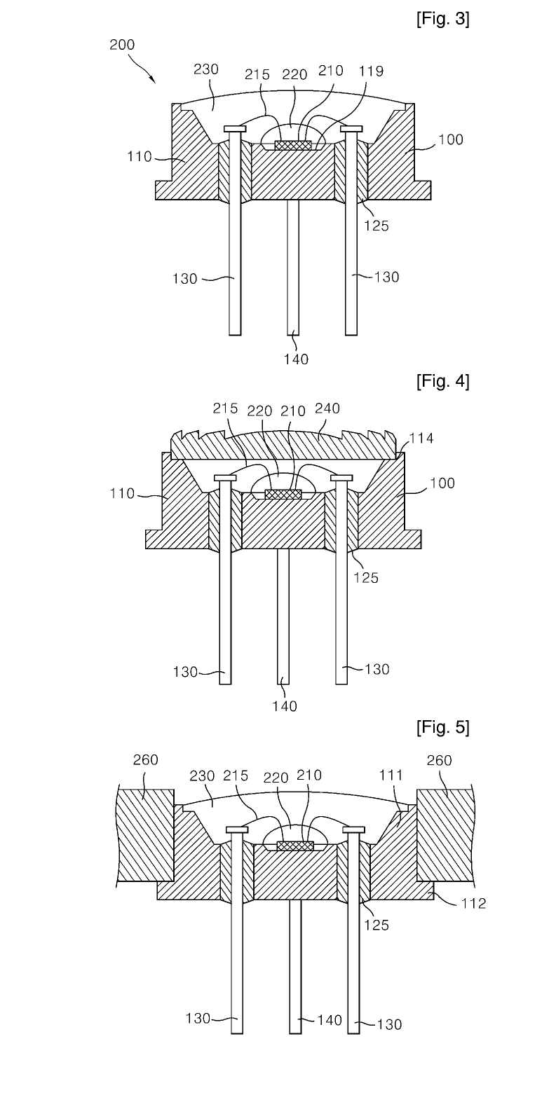

FIG. 3 is a cross-sectional view of a light emitting device to which the light emitting device package structure 100 is applied. Like reference numerals indicate like elements in FIGS. 1 through 3.

Referring to FIG. 3, a light emitting device 200 includes the light emitting device package structure 100 and a LED chip 210.

The LED chip 210 is mounted on a bottom surface 119 of the second receiving groove 117 and is electrically connected to the lead frame 130 by a conductive wire 215. Unlike the light emitting device 200 of FIG. 3, the LED chip 210 may be mounted on the heat-dissipating main plate 110 through a sub-mount (not shown).

Reference numeral 220 denotes a fluorescent substance 220, which is filled in the second receiving groove 117 to surround the LED chip 210 mounted on the bottom surface 119 of the second receiving groove 117. The fluorescent substance 220 may react with light radiated from the LED chip 210 and radiate white light. In this case, the LED chip 210 may be a blue light-emitting diode chip and the fluorescent substance 220 may be a YAG fluorescent substance. Alternatively, the LED chip 210 may be an ultraviolet emitting diode chip and the fluorescent substance 220 may be an RGB fluorescent substance.

Reference numeral 230 denotes a resin molding layer 230, which is used as a cap for sealing the internal space of the first receiving groove 113 and may be formed of various resin materials such as transparent epoxy resin.

Unlike the light emitting device 200 of FIG. 3, a lens that can be inserted into and combined with the lens mounting groove 114 may be mounted in the heat-dissipating main plate 110. For example, as shown in FIG. 4, a Fresnel lens 240 is combined with the lens mounting groove 114.

The Fresnel lens 240 is used as a cap for hermetically sealing the LED chip 210 and is soldered to the heat-dissipating main plate 110 through the lens mounting groove 114 of the heat-dissipating main plate 110. The soldering portion between the Fresnel lens 240 and the heat-dissipating main plate 110 is sealed by a sealing material to hermetically seal its internal space.

In the light emitting device 200, light radiated from the LED chip 210 mounted in the heat-dissipating main plate 110 is radiated at a desired divergence angle through the first inclined portion 115, the second inclined portion 118, and the Fresnel lens 240.

A material having a reflectivity that is similar to that of the Fresnel lens 240 may be filled in a space formed between the Fresnel lens 240 and the first receiving groove 113. For example, a silicon material may be filled in the space formed between the Fresnel lens 240 and the light emitting device package structure 100. In this case, the efficiency in the use of light may be improved by reducing a rate at which light radiated from the LED chip 210 is reflected from the inner side of the Fresnel lens 240.

Although not shown in the drawings, when an ultraviolet emitting diode chip is used, a flat-type lens may be soldered to the heat-dissipating main plate 110.

The flat-type lens may be formed of a transparent base plate whose top and bottom surfaces are anti-reflection coated. Various lens structures such as, but not limited to, the Fresnel lens 240 can be applied to the lens mounting groove 114 according to a light diffusion or focusing angle.

As mentioned above, to improve heat-dissipation capability, the ring-type auxiliary heat-dissipating member 260 that can be locked by and rested on the second body portion 112 may be inserted through the first body portion 111. In this case, the auxiliary heat-dissipating member 260 may be adhered to the heat-dissipating main plate 110 using an adhesive such as solder.

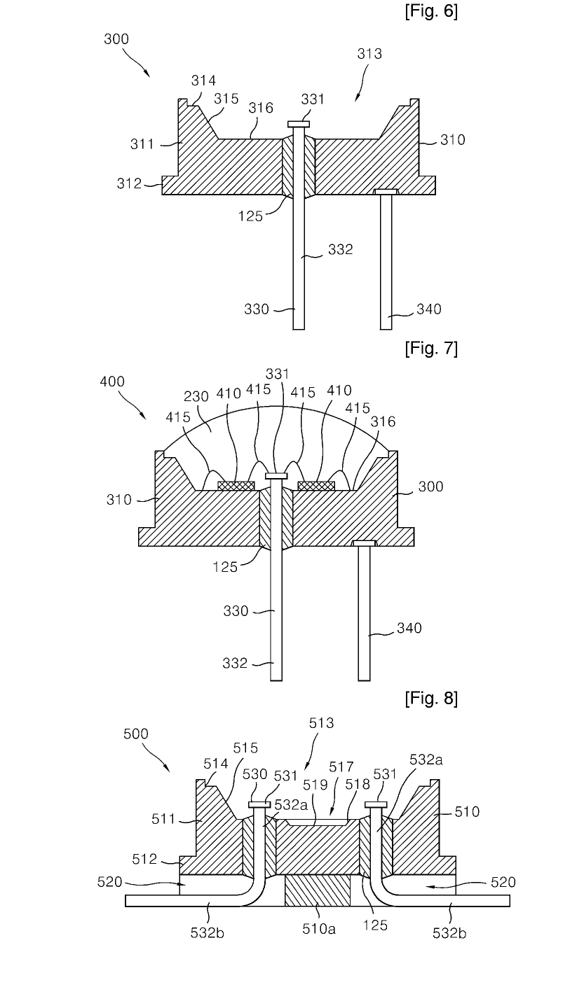

FIG. 6 is a cross-sectional view of a light emitting device package structure in which a plurality of LED chips is electrically connected by easily arranging the LED chips radially in the heat-dissipating main plate 110 when the heat-dissipating main plate 110 is formed of a conductive material or its surface is processed with a conductive material.

Referring to FIG. 6, a light emitting device package structure 300 includes a heat-dissipating main plate 310, a first lead frame 330, a second lead frame 340, and the insulating bead 125.

The heat-dissipating main plate 310 has an external structure in which a first body portion 311 and a second body portion 312 having an outer diameter that is larger than that of the first body portion 311 are formed.

The internal space of the heat-dissipating main plate 310 having an opened top includes a lens mounting groove 314 and a first inclined portion 315.

The insulating bead 125 penetrates the center of a bottom surface 316 of the first receiving groove 313. The lead frame 330 penetrates the insulating bead 125 such that its head portion 331 is exposed to the first receiving groove 313 and its leg portion 332 is protruded from the base of the heat-dissipating main plate 310, thereby being electrically insulated from the heat-dissipating main plate 310.

The second lead frame 340 is combined with the base of the heat-dissipating main plate 310 and is extended downwardly by a predetermined length.

Since the light emitting device package structure 300 can use the bottom surface 316 of the first receiving groove 313 of the heat-dissipating main plate 310 and the first lead frame 330 for electrode connection, a plurality of LED chips can be easily mounted and electrically connected on the heat-dissipating main plate 310 to be driven in parallel with one another.

FIG. 7 is a cross-sectional view of a light emitting device 400 to which the light emitting device package structure 300 is applied. Like reference numerals indicate like elements in FIGS. 1 through 6.

Referring to FIG. 7, the light emitting device 400 includes the light emitting device package structure 300 and a plurality of LED chips 410.

The LED chips 410 are mounted on the bottom surface 316 of the first receiving groove 313 of the heat-dissipating main plate 310 and are connected to the bottom surface 316 of the first receiving groove 313 of the heat-dissipating main plate 310 by a conductive wire 415 through the first lead frame 330. A cap 230 is molded by transparent epoxy resin.

Once the driving power is supplied to the light emitting device 400 through the first lead frame 330 and the second lead frame 340, the LED chips 410 mounted in the first receiving groove 313 emit light at the same time.

To create white light, three LED chips (not shown) radiating a red light, a green light, and a blue light, respectively, are mounted spaced apart from one another on the bottom surface 316 of the heat-dissipating main plate 310. Thus, an electrode of each of the plurality of LED chips 410 is connected to the first lead frame 330 by the conductive wire 415 through the head portion 331 of the first lead frame 330 and the other electrode of each of the LED chips 410 is connected to the bottom surface 316 of the heat-dissipating main plate 310 by the conductive wire 415, thereby creating white light.

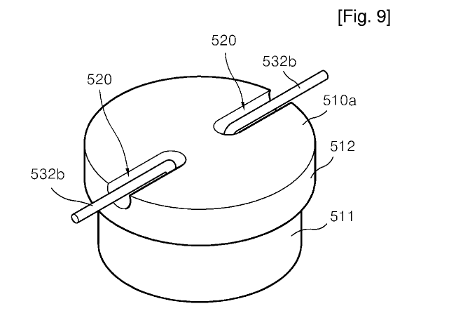

A lead frame may be bent to be suitable for surface mounting. FIGS. 8 and 9 illustrate an example of a light emitting device package structure including the bent lead frame.

Referring to FIGS. 8 and 9, a light emitting device package structure 500 includes a heat-dissipating main plate 510, a lead frame 530, and the insulating bead 125.

The heat-dissipating main plate 510 has an external structure in which a first body portion 511 and a second body portion 512 having an outer diameter that is larger than that of the first body portion 511 are formed. The second body portion 512 is expanded larger than the first body portion 511, but may take other shapes in addition to a circular shape shown in the drawings. The internal space of the heat-dissipating main plate 510 having a first receiving groove 513 with an opened top includes a lens mounting groove 514 and a first inclined portion 515, and a second receiving groove 517 having a second inclined portion 518 in the center of the bottom surface of the first receiving groove 513.

In a base 510a of the second body portion 512 of the heat-dissipating main plate 510, a plurality of third receiving grooves 520 whose number is equal to the number of lead frames 530 is formed spaced apart from one another. The third receiving grooves 520 are cut from the inner portion to the outer portion of the base 510a to a pre-determined length, so that the lead frames 530 can be accommodated in the third receiving grooves 520 while being spaced apart from one another.

In other words, the third receiving grooves 520 are formed in the base 510a of the heat-dissipating main plate 510 to be cut to a predetermined depth from the base 510a towards the inner portion of the second body portion 512 and be extended to the outer circumference of the second body portion 512, so that bent portions 532b of the lead frames 530 are accommodated in the third receiving grooves 520 while being spaced apart from the third receiving grooves 520 by a predetermined distance.

The lead frame 530 has a structure in which a leg portion extended downwardly from a head portion 531 includes a vertical portion 532a and the bent portion 532b.

In other words, the leg portion of the lead frame 530 that penetrates the insulating bead 125 and is protruded from the base 510a of the heat-dissipating main plate 510 for surface mounting includes the bent portion 532b that is bent in parallel with the base 510a of the heat-dissipating main plate 510 and is extended while being spaced apart from the base 510a of the heat-dissipating main plate 510.

Thus, in the light emitting device package structure 500, surface mounting is possible through the bent portion 532b of the lead frame 530.

In addition, in the light emitting device package structure 500, as described with reference to FIGS. 3 and 4, the LED chip is mounted in the second receiving groove 517 of the heat-dissipating main plate 510, an electrode of the LED chip and the lead frame 530 are electrically connected using a conductive member such as a conductive wire, and then a light emitting device is manufactured after fluorescent substance application and lens combination or molding using capping resin.

Hereinafter, a method of manufacturing a light emitting device package structure according to the present invention will be described.

First, the heat-dissipating main plates 110, 130, and 510 are formed of corresponding heat-dissipating materials. At least one insertion hole is formed in the heat-dissipating main plates 110, 310, 510. The insulating bead 125 for mounting a lead frame that should be electrically insulated from the heat-dissipating main plates 110, 130, and 510 is inserted into the insertion hole.

It is preferable that the heat-dissipating main plates 110, 130, and 510 be plated with nickel after being formed to have the insertion hole.

Next, the insulating bead 125 having a hollow is inserted into the insertion hole of the heat-dissipating main plates 110, 310, and 510. The outer diameter of the insulating bead 125 may be equal to or smaller than the inner diameter of the insertion hole, so that the insulating bead 125 can be inserted into and combined with the heat-dissipating main plates 110, 310, and 510. Next, the lead frames 130, 330, and 530 having leg portions whose outer diameters are equal to that of the hollow of the insulating bead 125 are inserted through the hollow of the insulating bead 125, such that the head portions 131, 331, and 531 are positioned within the first receiving grooves 113, 313, and 513.

Alternatively, after the lead frames 130, 330, and 530 are first inserted into the insulating bead 125, the insulating bead 125 may be inserted into the insertion holes of the heat-dissipating main plates 110, 310, and 510.

Next, heating is applied to the insulating bead 125 such that the insulating bead 125 is adhered to the heat-dissipating main plates 110, 130, and 510 and the lead frames 130, 330, and 530 by being melted or sintered.

For example, when the insulating bead 125 is formed of a glass material, a structure in which the insulating bead 125 and the lead frames 130, 330, and 530 are assembled in the heat-dissipating main plates 110, 310, and 510 is placed in an electric furnace and is then heated at a temperature of 600-1000? under a nitrogen and hydrogen atmosphere. Here, nitrogen is applied to prevent oxidation and hydrogen is applied to facilitate deoxidization of an oxidized portion. Heating continues so that the insulating bead 125 can be welded to the heat-dissipating main plates 110, 310, and 510 and the lead frames 130, 330, and 530.

After the completion of the process, once the melted portion of the insulating bead 125 is left at room temperature to be solidified, the light emitting device package structures 100, 300, and 500 are completed.

To form the bent portion 532b in the lead frame 530, a bending process is performed. When the lead frames 140 and 340 are directly combine with the heat-dissipating main plates 110, 310, and 510 without being inserted into the insulating bead 125, they are soldered using a brazing sheet or a metal paste. Here, the brazing sheet or the metal paste may be formed of a silver-copper alloy or a gold-tin alloy.

After the completion of such an assembly, conductive and reflecting portions, i.e., the heat-dissipating main plates 110, 310, and 510 and the lead frames 130, 330, and 530 are plated with nickel and are then secondarily plated with silver.

Alternatively, the inner sides of the first receiving grooves 113, 313, and 513 of the heat-dissipating main plates 110, 310, and 510 are coated with at least one of a reflection material group including aluminum and bright nickel.

After the completion of the light emitting device package structures 100, 300, and 500, the LED chips 310 and 410 are mounted in the first receiving grooves 113, 313, and 513 of the heat-dissipating main plates 110, 310, and 510 directly or through a sub-mount (not shown). The LED chips 210 and 410 are bonded to the lead frames 130, 330, and 530 or the heat-dissipating main plates 110, 310, and 510 by the wires 215 and 415.

When the fluorescent substance 220 is used, it is applied to the wire-bonded LED chips 210 and 410.

The Fresnel lens 240 is then inserted into the heat-dissipating main plates 110, 310, and 510. A combined portion between the Fresnel lens 240 and the lens mounting grooves 114, 314, and 514 is sealed by a sealing material, e.g., an epoxy material or a cap is formed by filling the first receiving grooves 113, 313, and 513 with molding resin, thereby completing the light emitting devices 200 and 400.

The foregoing description is made about a case where an LED chip is used, but the present invention can also be applied to various well-known light emitting semi-conductor chips such as a laser diode chip.

### INDUSTRIAL APPLICABILITY

According to the present invention, an LED chip can be mounted on a large-scale heat-dissipating main plate and light can be focused, thereby improving light emitting efficiency and heat-dissipating capability.

1. A light emitting device package structure comprising:
a heat-dissipating main plate formed of a heat-dissipating material, in which a first receiving groove has an opened top and a first inclined portion has an inner diameter that gradually decreases toward a lower position;
at least one insulating bead which is formed of an insulating material and penetrates a bottom surface of the first receiving groove from a base of the heat-dissipating main plate; and
at least one lead frame which penetrates the insulating bead.

2. The light emitting device package structure of claim 1, wherein the heat-dissipating main plate includes a second receiving groove that is cut to a pre-determined depth in the center of the bottom surface of the first receiving groove to mount a light emitting device chip.

3. The light emitting device package structure of claim 2, wherein the second receiving groove has a second inclined portion whose outer diameter gradually decreases towards a lower position.

4. The light emitting device package structure of claim 1, wherein the insulating bead is formed of one of a glass material and insulating synthetic resin.

5. The light emitting device package structure of claim 1, wherein the heat-dissipating main plate comprises:
a first body portion which is extended to a predetermined length from its top to have the same outer diameter from top to bottom; and
a second body portion which is extended concentrically with the first body portion by a predetermined length from the bottom of the first body portion to have an outer diameter that is larger than that of the first body portion.

6. The light emitting device package structure of claim 1, wherein the heat-dissipating main plate further comprises a lens mounting groove that has a step of a predetermined depth from the top edge of the first body portion and is then extended to the top of the first inclined portion.

7. The light emitting device package structure of claim 1, wherein the first insulating bead is formed in the center of the heat-dissipating main plate, the light emitting device further comprising:
a first lead frame which penetrates the first insulating bead; and
a second lead frame which is formed in the base of the heat-dissipating main plate.

8. The light emitting device package structure of claim 1, wherein the lead frame has a bent portion that is bent in parallel with the base of the heat-dissipating main plate and is extended while being spaced apart from the base of the heat-dissipating main plate, in which the lead frame penetrates the heat-dissipating main plate for surface mounting.

9. The light emitting device package structure of claim 8, wherein in the base of the heat-dissipating main plate, at least one third receiving groove is further formed, in which the third receiving groove is cut from the inner portion to the outer portion of the base of the heat-dissipating main plate to a predetermined length, so that the bent portion is partially accommodated in the third receiving groove while being spaced apart from the third receiving groove.

10. The light emitting device package structure of claim 1, wherein at least the first inclined portion of the heat-dissipating main plate has a surface formed of at least one of nickel, silver and aluminum.

11. A light emitting device comprising:
a heat-dissipating main plate formed of a heat-dissipating material, in which a first receiving groove has an opened top and a first inclined portion has an inner diameter that gradually decreases toward a lower position;
at least one insulating bead which is formed of an insulating material and penetrates a bottom surface of the first receiving groove from a base of the heat-dissipating main plate;
at least one lead frame which penetrates the insulating bead;
at least one light emitting device chip which is mounted in the first receiving groove of the heat-dissipating main plate and is electrically connected to the lead frame; and
a cap which is formed in the heat-dissipating main plate to hermetically seal the internal space of the first receiving groove in which the light emitting device chip is mounted.

12. The light emitting device of claim 11, wherein the heat-dissipating main plate includes a second receiving groove that is cut to a predetermined depth in the center of the bottom surface of the first receiving groove to mount a light emitting device chip.

13. The light emitting device of claim 12, wherein the second receiving groove has a second inclined portion whose outer diameter gradually decreases towards a lower position.

14. The light emitting device of claim 13, further comprising a fluorescent substance filled in the second receiving groove to surround the LED chip mounted on the second receiving groove.

15. The light emitting device of claim 11, wherein the heat-dissipating main plate comprises:
a first body portion which is extended to a predetermined length from its top to have the same outer diameter from top to bottom; and
a second body portion which is extended concentrically with the first body portion by a predetermined length from the bottom of the first body portion to have an outer diameter that is larger than that of the first body portion.

16. The light emitting device of claim 11, wherein the heat-dissipating main plate further comprises a lens mounting groove that has a step of a predetermined depth from the top edge of the first body portion and is then extended to the top of the first inclined portion, and the cap is a lens inserted into and combined with the lens mounting groove to be mounted in the heat-dissipating main plate.

17. The light emitting device of claim 11, wherein the first insulating bead is formed in the center of the heat-dissipating main plate, the light emitting device further comprising:
a first lead frame which penetrates the first insulating bead; and
a second lead frame which is formed in the base of the heat-dissipating main plate, the light emitting device chip being mounted in the first receiving groove of the heat-dissipating main plate and electrically connected to the first lead frame and the heat-dissipating main plate.

18. A method of manufacturing a light emitting device package structure, the method comprising:
forming a heat-dissipating main plate having a first receiving groove and at least one insertion hole, in which the first receiving groove has an opened top, a first inclined portion has an inner diameter that gradually decreases toward a lower position, and the insertion hole penetrates a bottom surface of the first receiving groove;
inserting an insulating bead having a hollow into the insertion hole of the heat-dissipating main plate and inserting a lead frame through the hollow of the insulating bead; and
performing a heating process to solder the insulating bead to the heat-dissipating main plate and the lead frame.
